(19) United States
(12) Patent Application Publication
(10) Pub. No.: US 2010/0281834 A1
(43) Pub. Date: Nov. 11, 2010

(54) Filtration heat transfer system

(76) Inventors: David K. Friday, Baltimore, MD (US); Steven Skinner, Willoughby, OH (US); Ken Kessler, Streetsboro, OH (US); John L. Creed, Niles, OH (US); James Sackett, JR., Mentor, OH (US)

Correspondence Address: FAY SHARPE LLP, 1228 Euclid Avenue, 5th Floor, The Halle Building, Cleveland, OH, 44115, US

(21) Appl. No.: 12/072,569

(22) Filed: Feb. 27, 2008

Related U.S. Application Data
(60) Provisional application No. 60/903,769, filed on Feb. 27, 2007.

(51) Int. Cl. B01D 46/42

(52) U.S. Cl. 55/490.2; 55/529

(57) ABSTRACT

A filter cooling construction includes a mass of filtration material held in a filter body and a cooling member extending in the mass of filtration material. A manifold communicates with the cooling member for channeling a cooling fluid to the cooling member. In another embodiment, a heat transfer construction is provided so that a temperature control fluid can flow to the heat transfer member thereby selectively heating and cooling the mass of filtration material. Once use for such constructions is in air filters.

### BACKGROUND

This application claims the benefit of U.S. Provisional Application Ser. No. 60/903,769 filed on Feb. 27, 2007.

Air handling systems now frequently include filtration systems that can protect and an enclosure against noxious airborne agents released in the vicinity of the enclosure. Such agents include nuclear, biological or chemical agents (known as NBC).

Standard filters are ineffective against such NBC agents and even HEPA (high efficiency particulate arrest) filters are incapable of filtering out all such agents.

Military vehicles in particular may be exposed to NBC agents, as well as nuclear hazards. As a result, such vehicles need to be equipped with nuclear, biological and chemical life support systems to facilitate operations under such hazardous conditions.

Contaminating agents are often removed from gases, such as air, by the use of low pressure activated carbon filter bed units, including those that have been impregnated with agents which increase the sorption capacity of the filter for particular agents. These, however, are known to be limited in use when applied to systems for supplying air to an entire living area, as opposed to an individual. The reason for this is because such filtration systems require frequent replacement due to limitations in service life, with resultant regimes of replacement at regular intervals needed if problems are to be avoided. While replacement of filter canisters for individual masks take relatively little effort, filter replacements in a vehicle or a stationary structure provides significant logistics problems.

In order to avoid these problems, other types of filtration systems have been developed for removal of contaminants in air supplied in a collective protection scenario (i.e. for a vehicle crew compartment or a stationary structure), particularly using thermal swing absorption (TSA) technology. Therefore, it is now known that filters can be regenerated. One known such system is disclosed in U.S. Pat. No. 7,115,152, the disclosure of which is incorporated hereinto by reference in its entirety.

Temperature swing regeneration utilizes heat to remove the contaminant from the adsorbent material and allow the adsorbent material to be reused. There are many industries which utilize thermal or temperature swing adsorption processes. Such applications include solvent recovery, air drying and removing contaminants, such as CO₂ and H₂O from air prior to cryogenic separation.

Typically, in most regenerable adsorption-based air purification systems, there are two major steps to a cycle, namely; (1) feed and (2) regeneration. A great deal of design attention is normally focused on the feed step to prevent the target contaminant chemical(s) from penetrating into the product. The complexity and importance of the regeneration step is given less attention. For regenerable systems, it is the efficiency of the regeneration step that determines whether the system can meet the power consumption, size and weight constraints. This is true for both Pressure Swing Adsorption (PSA) and Thermal Swing Adsorption (TSA) technologies.

The rest of this discussion will focus on TSA system design. The regeneration step in a TSA system can be divided into 2 parts, namely; (1) heating and (2) cooling. After a bed has reached the end of a feed step, the adsorbent must be heated to a desired regeneration temperature and, while at temperature, clean product air must be introduced to sweep the adsorbed contaminant(s) out of the bed. But the bed must be cooled back to ambient temperature prior to being placed back on stream to process feed gas. Typically, in TSA systems, this is accomplished using product air without heat. The major problem with approach is that temperature waves formed in the bed become very disperse because of heat transfer resistances as well as axial dispersion. Therefore it takes a lot purge gas (product) to cool the bed sufficiently to allow the next feed step to begin. For air purification systems that remove relatively weakly adsorbed contaminant gases (e.g., chloroethane), if the bed is not cooled completely (several degrees Kelvin) to within the desired feed temperature, when the feed step is resumed, the contaminant gas in the feed will penetrate much further in the filter bed than desired. Eventually after several cycles, the contaminant gas will penetrate into the vehicle crew compartment or stationary structure imperiling the personnel therein.

So the current problem is this. The bed must be cooled sufficiently to prevent the contaminant vapor(s) from eventually penetrating into the crew compartment of a vehicle or the stationary structure. A typical approach in adsorption systems is to increase the bed size. This will not work for regenerable systems. While increasing the bed size will obviously allow the bed to stay in the feed mode longer, the increased adsorbent inventory must still be heated and COOLED. Everything else being equal, it will take proportionally the same amount of time to compete the regeneration step. So there is nothing gained by making the beds larger. The normal answer to this dilemma is to increase the purge gas flow rate. But, this obviously increases the feed flow rate (a constant product flow rate must be maintained) as well as the energy requirements. Therefore, it is the EFFICIENCY of the regeneration step that is critical to optimizing system design for TSA. In particular, the goal is to add AND remove heat from the adsorbent as quickly as possible using as little purge (product) gas as possible.

Previous works have shown that efficiency of the regeneration step can be improved by heating the adsorbent directly with little or no gas purge (product) gas flow. These approaches include: (1) electrically resistive heating elements, (2) electrical potential across the adsorbent material itself and (3) microwave heating. All of these approaches can improve the regeneration step efficiency by adding heat quickly and directly to the adsorbent. But after heating, the cooling step is still accomplished by passing purge gas through the bed. This adds to the overall cycle time and it adds to the total purge gas requirement. Each of these has a large negative impact on the regeneration step efficiency.

Not only heating but cooling of the adsorbent directly is provided herein, in order to greatly increase the regeneration step efficiency. Such cooling will allow one to design and build smaller, less energy intensive, TSA systems for air purification applications. Both heating and cooling will be accomplished by configuring an adsorbent bed with elements that will allow heat transfer fluid to be passed through elements that contact the adsorbent media itself. The heat transfer fluid can be either hot or cold, depending upon whether the bed is in the heating mode or the cooling mode. The number of heat transfer elements and their configurations can vary but the objective is to provide as much heat transfer surface as possible, while allowing for enough adsorbent to provide the required contaminant retention capacity. Regeneration step capacity is thus increased by adding and removing heat quickly, thus reducing cycle time and overall purge gas requirements.

### BRIEF SUMMARY

According to one embodiment of the disclosure, a filter cooling construction comprises a mass of filtration material held in a filter body. A cooling member extends in the mass of filtration material. A manifold communicates with the cooling member for channeling a cooling fluid to the cooling member.

According to another embodiment of the present disclosure, a heat transfer construction is provided for an air filter. The heat transfer construction comprises a mass of filtration material held in a filter housing and a heat transfer member extending in the mass of filtration material. A manifold communicates with the heat transfer member for channeling a temperature control fluid to the heat transfer member, thereby selectively heating and cooling the mass of filtration material.

In accordance with still another embodiment of the disclosure, a heat transfer system is provided for an air filter. The system comprises a filter body including a wall and a filtration material held within the wall. A heat transfer member extends in the filtration material. The heat transfer member comprises at least one channel through which a temperature control fluid flows. A manifold communicates with the heat transfer member at least one channel for directing the temperature control fluid toward and away from the heat transfer member.

### BRIEF DESCRIPTION OF THE DRAWINGS

FIG. 1 is a perspective view of a heated and cooled filter according to a first embodiment of the present disclosure;

FIG. 2 is an enlarged perspective view of a portion of a heat transfer fin of the filter of FIG. 1 in cross-section;

FIG. 3 is an enlarged front elevational view of a portion of the heat transfer fin of the filter of FIG. 1 in cross-section;

FIG. 4 is a schematic view of a heat transfer fin according to another embodiment of the present disclosure;

FIG. 5 is a schematic view of a heat transfer system according to one embodiment of the present disclosure; and,

FIG. 6 is a top plan view of a heated and cooled filter according to a second embodiment of the present disclosure.

### DETAILED DESCRIPTION

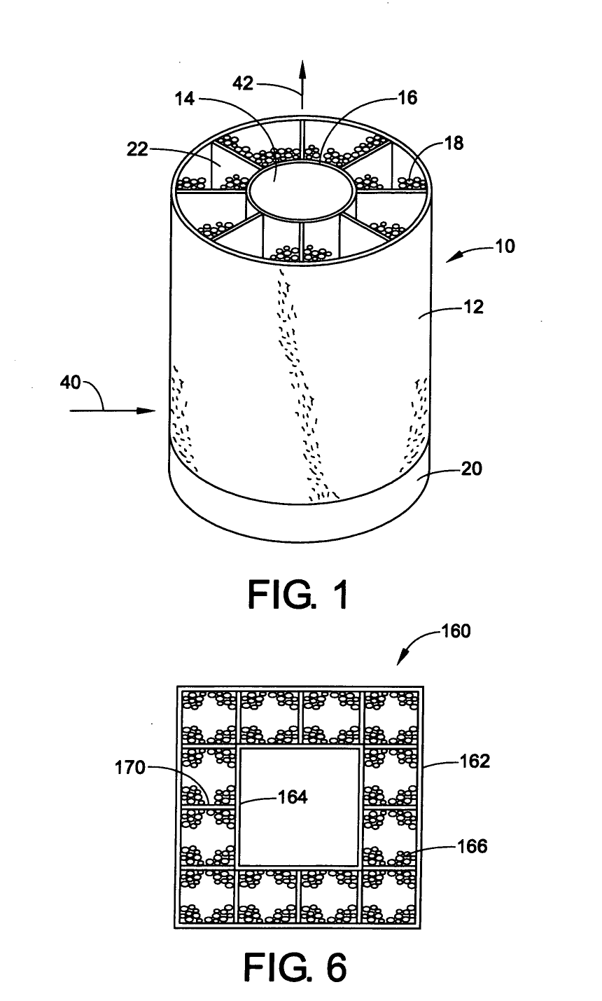

With reference to FIG. 1, a first embodiment of a filter according to the instant disclosure includes a cylindrical filter body 10 comprising an outer wall or outer surface 12 and an inner wall or inner surface 14. In this embodiment, the filter body is annular in shape defining a central opening 16 extending therethrough. The two walls hold between them a filter element such as a particulate filtration material 18 which removes contaminants form the air being filtered. It should be appreciated that the walls 12 and 14 are porous so as to allow a fluid to flow therethrough. In one embodiment, the fluid is air meant to be filtered. The porous nature of at least the outer wall 12 is illustrated in FIG. 1. In this embodiment, the filter is mounted on a manifold 20.

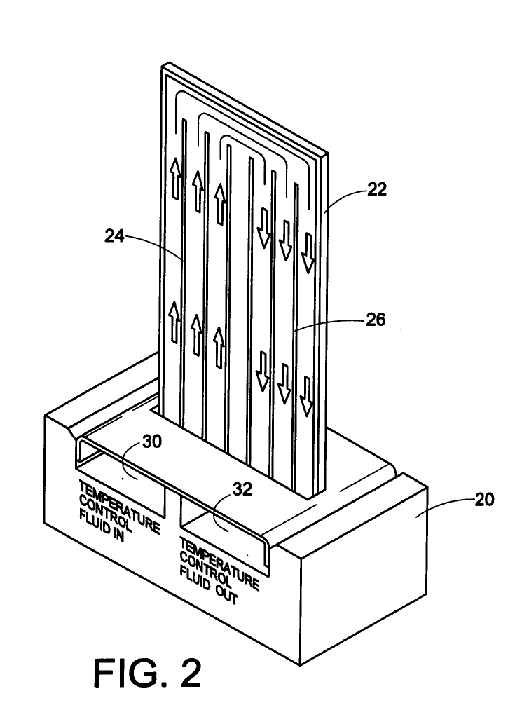

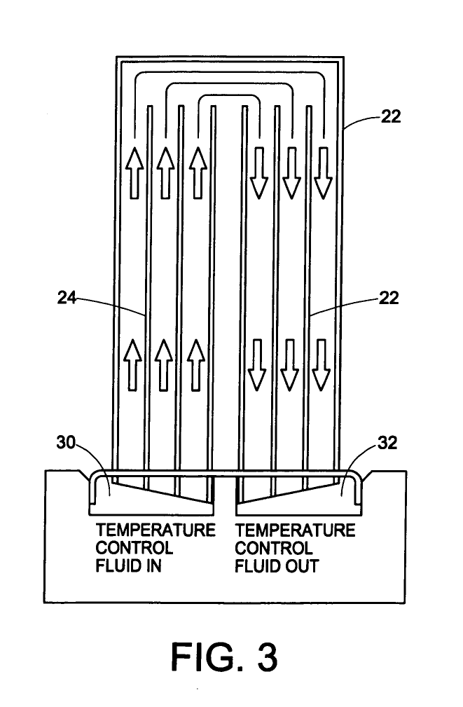

With reference now also to FIG. 2, connected to the manifold and mounted thereon are a plurality of spaced heat transfer elements or members 22. The heat transfer element can be in the form of a micro channel heat exchanger employing fins. More particularly, one such design employs one or more inlet channels 24 and one or more outflow channels 26. The inlet channels communicate with a temperature control fluid inlet conduit 30 and the outflow channels 26 communicate with a temperature control fluid outlet conduit 32. Needless to say, the inlet channels communicate with the outflow channels, although that is not clearly shown in FIGS. 2 and 3. Both of the conduits 30 and 32 are defined in the manifold 20. As can best be seen from FIG. 3, heating fluid or coolant fluid is wicked up into the fin 22 via the fluid inlet channels 24. The fluid transfers heat to or picks up heat from the filtration material and exits via channels 26 which allow the fluid to circulate away.

As is known, the filtration material or filtering medium operates to remove contaminants as the air passes through the filter in a radial direction as shown by arrow 40. Once the air has passed through the filter body 10, it exits in an axial direction such as is shown by arrow 42 in FIG. 1. The filtering media is often formed from a granulated material, for example, an activated carbon. Of course, a plethora of other types of filtration material can be employed as well. The fins 22 can be made from a conventional aluminum material or other known materials.

It should be apparent that the heat transfer fins are oriented radially so as to interfere as little as possible with flow of air through the filter body 10. Thus, air will flow on either side of the heat transfer fin 22 from the filter outer surface 12 to the filter inner surface 14 in an uninterrupted manner. While as much heat transfer surface as possible is provided by the fins 22, they interfere as minimally as possible with air flow through the filter.

The heat transfer fluid employed can be any of the known types heat transfer fluids. For example, certain hydroflorocarbons, such as HFC-134A or HFC-152A can be employed. In addition, CO₂ or ammonia can be employed as the heat transfer fluid. All that is necessary is that the fluid be capable of both adding heat to the filtration material and removing heat from the filtration material in an efficient manner.

The heat transfer fluid enters the one or more inlet channels 24 in each heat transfer member or fin 22 and exits via the one or more outflow channels 26 therein. In this manner, heat is either transferred to or removed from the filtration material. In the illustrated embodiment, the channels 24 and 26 are aligned with a longitudinal axis of the fin 22. Of course, other designs for the micro channels can also be employed. For example, curvilinear configurations can be used as well. Also, in the illustrated embodiment, the channels are substantially equally spaced from one another. However, alternate constructions of the heat transfer member or fin may include channels at different spacings from each other or different numbers of inlet and outflow channels. In addition, different concentrations of channels may be employed at different segments of the fin 22. Channels 24 and 26 of a particular, and constant, diameter are schematically illustrated in FIGS. 2 and 3. However, the channels could have different diameters if so desired. Also, alternate constructions may include a fin 22 with inlet and outflow channels having non circular cross sectional shapes, as well as circular cross sections, elliptical cross sections, square cross sections and the like. Several such micro channel heat transfer fins are known in the art.

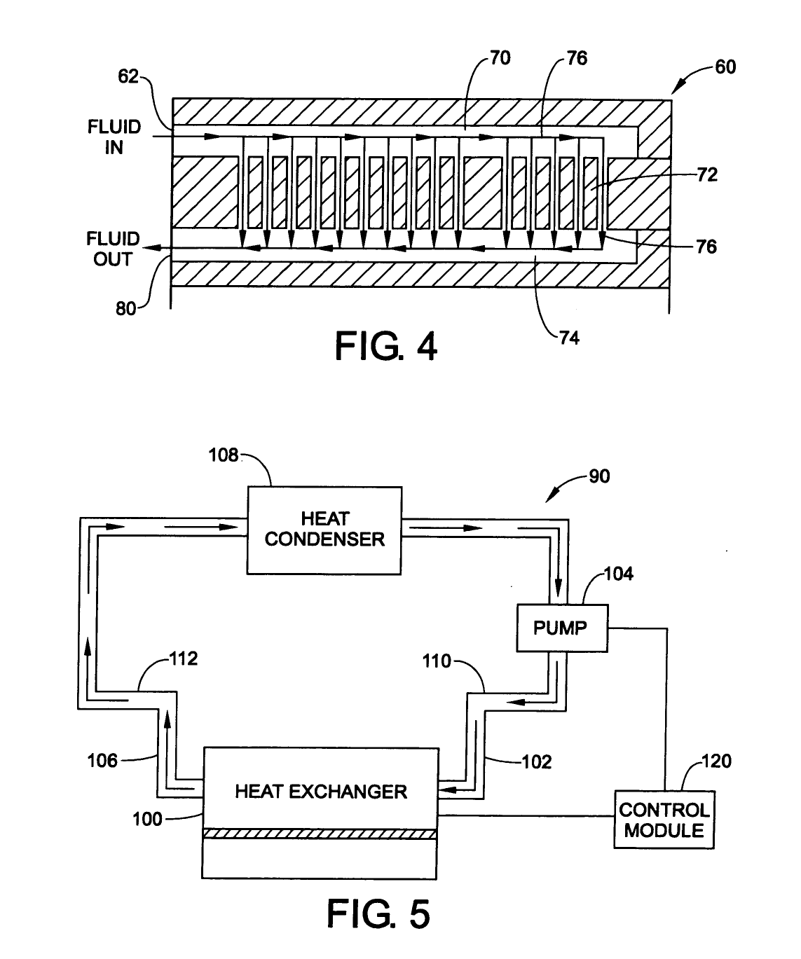

Another embodiment of a cooling fin is illustrated in FIG. 4. In this embodiment, a fin 60 includes a fluid inlet port 62 which leads to at least one fluid inlet conduit 70. The fluid inlet conduit is connected via a plurality of cross flow conduits 72 to a fluid outlet conduit 74. Thus, the fluid flows in a direction illustrated by arrows 76. Fluid subsequently flows out a fluid outlet port 80. As previously mentioned, the fluid is a heat transfer fluid that can either add heat to or remove heat from a filter. It is noted that in this embodiment, the fin is oriented transverse to its orientation in the first embodiment. Of course, the fin can take any orientation as may be necessary to be accommodated in the filter in which it is used.

With reference now to FIG. 5, a schematic diagram of a closed loop heat transfer system 90 is there illustrated. In this embodiment, a heat exchanger 100 of any desired shape is provided for a filter (not shown), such as the filter illustrated in FIG. 1. As shown in this embodiment, a fluid inlet port 102 allows the heat transfer fluid to flow from a pump 104 to an inlet of the heat exchanger unit coupled to a filter. A fluid outlet port 106 allows the spent fluid to be removed from the vicinity of the filter. The pump 104 pumps and circulates fluid within the closed loop as shown. A heat condenser 108 in the system 90 allows heat to be either removed from the heat transfer fluid or added thereto, as may be required at a particular time in the thermal swing adsorption system described herein. It should be apparent that fluid lines 110 and 112 communicate the heat condenser 108 with the pump 104 and the heat exchanger 100. A control module 120 controls the entire system and actuates the pump to circulate fluid to either add heat to or remove heat from the filter via the heat exchanger, as may be necessary in order to operate the temperature swing adsorption system in an efficient manner.

With reference now to FIG. 6, another embodiment of the instant disclosure is there illustrated. In this embodiment, rather than employing a cylindrical filter, a square or rectangular filter is illustrated. To this end, a filter body 160 includes an outer wall 162 and an inner wall 164. A filtration material 166 is held between the two walls of the filter. Protruding longitudinally into the filtration material are a plurality of fins 170. The fins allow the filter to be heated or cooled as desired. As mentioned, such heat transfer is beneficial in increasing the efficiency of the regeneration step in the filter. In particular, cooling of the filter disclosed herein allows for the design of smaller and less energy intensive filtration systems employing thermal swing absorption for air purification applications.

While FIGS. 1 and 6 have illustrated two particular filter designs, it should be appreciated that there are any number of other types of filter designs in which the filtration material, whether it be granular or otherwise, can be treated with the heat transfer construction disclosed herein. In other words, there are many types of filters in which either a cooling of the filter or a heating of the filter or both would be desirable.

The filters 10 and 160 illustrated in FIGS. 1 and 6 are discussed as being employed for filtering air. However, it should be appreciated that such filters can be used for filtering a variety of other types of gases and liquids. Heat transfer to and from such filters would be advantageous in a number of settings other than air filtration. The teachings of this disclosure are equally applicable to the use of filters in a variety of environments other than air filtration.

It should also be appreciated that the material flowing through the fins can be employed to heat or cool the filter as is necessary in thermal swing absorption. Thus, the heat transfer fluid can either be hot or cold, depending upon whether the filter bed is in the heating mode or the cooling mode.

While one particular type of heat transfer element, in the form of fins, has been described herein, it should be appreciated that a variety of other types of known heat transfer elements can be employed instead. The objective is, however, to provide as much heat transfer surface for the filter as possible, while allowing for enough adsorbent, i.e., filtration material, to provide the required contaminant retention capacity. It should be appreciated that the heat transfer element or member can take forms other than the types of fins which are disclosed herein. All that is necessary is that the heat transfer member have a minimized resistance to air flow through the filter body while increasing a heat transfer area with the filtration material. While fins are one example of such a heat transfer member, other types of heat transfer members are also contemplated.

With the provision of heating and cooling of the filters, the regeneration step capacity of the thermal swing absorption filter as discussed herein can be greatly enhanced because heat can be added and removed quickly, thus reducing cycle time and overall requirements for purge gas in a filtration system.

As noted, in order to improve the performance of a regenerable filtration system, it is necessary to heat and cool the filter media as rapidly and efficiently as possible. Thus, in one embodiment, the regenerable filtration system is supplied with an integral environmental control unit (ECU). The ECU is a vapor cycle heat pump system or air-conditioning cooling system. The ECU offers air or fluid type heat exchangers. By combining two such systems, one is able to make use of much of the waste ECU heat energy that would normally be discarded, dramatically improving both the filtration and the ECU system heat efficiencies. One such integral environmental control unit or ECU is disclosed in application Ser. No. 11/973,466 dated Oct. 9, 2007. The disclosure of that application is incorporated hereinto in its entirety.

The filtration bed temperature of the filters discussed herein is maintained by placing a number of heat exchanging elements directly within the filtration media. These heat exchanging elements can be arranged throughout the media to provide for rapid temperature manipulation of the filtration media, as required by the regenerative filter system. These heat exchanger elements can be configured in multiple ways. In one design, the individual elements are capable of both heating and cooling the filter media. However, other designs are also contemplated in which individual heating only and cooling only elements can be placed throughout the filter bed, as required by the particular design and regenerative cycle.

The temperature manipulating elements themselves can take many forms, depending on the constraints of the particular installation. For example, when combined with the ECU, refrigerant could be routed through the filtration media through the use of tubes of various cross sections, micro channel tube elements as found normally in refrigeration applications, extrusions and any other shape that would serve to conduct the refrigerant through the particulate material and the filter material (such as carbon) in the required manner.

Other heat exchanging elements could also be used depending upon the availability of refrigerant and the construction of the filter sorbent bed. In these applications, items, such as heat pipes, plate exchangers, etc., could be used in order to control the sorbent temperature. In cases where it is impossible to place the heat exchanging elements inside the filter bed, it is also possible to locate them at the inlet and/or outlet air streams of the filter bed and maintain or achieve the desired temperature in that manner.

For example, a cold base can be provided for the filtration medium or heat pipes can be employed to add heat to or remove heat from the filtration material. As mentioned, separate heating and cooling elements may be employed for the filter or filters, as well. It should be evident that the precise shape of the heat transfer elements for the filters is dependent to a large extent upon the shapes of the filters themselves, as well as the installation into which the filters are placed, i.e., an ECU or another form of filtration system employed in a vehicle crew compartment or in a stationary installation, such as a tent, a building or the like.

The disclosure has been described with reference to several preferred embodiments. Obviously, modifications and alterations will occur to others upon the reading and understanding if this specification. The disclosure is intended to include all such modifications and alterations insofar as they come within the scope of the appended claims or the equivalents thereof.

1. A filter cooling construction comprising:
mass of filtration material held in a filter body;
a cooling member extending in said mass of filtration material; and, a manifold communicating with said cooling member for channeling a cooling fluid to said cooling member.

2. The construction of claim 1 wherein said cooling member comprises a fin.

3. The construction of claim 2 wherein said fin is oriented approximately transverse to a direction of a fluid to be treated as it flows through said mass of filtration material.

4. The construction of claim 2 wherein said fin comprises a plurality of channels through which the cooling fluid flows.

5. The construction of claim 1 wherein said filter body has an annular shape including an outer wall and an inner wall, said mass of filtration material being disposed therebetween.

6. The construction of claim 5 wherein a plurality of fin-like cooling members are disposed in a spaced manner in said filter body, said manifold communicating with each of said cooling members.

7. The construction of claim 1 further comprising a pump communicating with said manifold for pressurizing the cooling fluid.

8. The construction of claim 7 further comprising a control module in communication with said manifold and said pump for controlling an operation of said pump.

9. The construction of claim 8 further comprising a heat condenser and at least one fluid line which communicates said manifold and said pump with said heat condenser.

10. The construction of claim 1 wherein said cooling member comprises a plurality of channels through which the cooling fluid flows.

11. A heat transfer construction for an air filter comprising:
a mass of filtration material held in a filter housing;
a heat transfer member extending in said mass of filtration material; and
a manifold communicating with said heat transfer member for channeling a temperature control fluid to said heat transfer member, thereby selectively heating and cooling said mass of filtration material.

12. The construction of claim 11 wherein said heat transfer member comprises a fin.

13. The construction of claim 11 wherein said heat transfer member is oriented approximately transverse to a direction of airflow through said mass of filtration material.

14. The construction of claim 11 wherein said heat transfer member comprises a plurality of channels through which the temperature control fluid flows.

15. A heat transfer system for an air filter, comprising:
a filter body including a wall and a filtration material held within said wall;
a heat transfer member extending in said filtration material, said heat transfer member comprising at least one channel through which a temperature control fluid flows; and
a manifold communicating with said heat transfer member at least one channel for directing the temperature control fluid toward and away from the heat transfer member.

16. The system of claim 15 wherein said heat transfer member is relatively wide and relatively thin in order to minimize a resistance to airflow through said filter body while increasing a heat transfer area with said filtration material.

17. The system of claim 15 wherein said heat transfer member is oriented approximately transverse to a direction of airflow through said filtration material in order to minimize a resistance to airflow.

18. The system of claim 15 further comprising:
a pump communicating with said manifold for pressurizing the temperature control fluid; and,
a control module in communication with said manifold and said pump for controlling an operation of said pump.

19. The system of claim 18 further comprising:
a heat condenser; and
at least one fluid line which communicates said manifold, said heat condenser and said pump.

20. The system of claim 15 wherein a plurality of heat transfer members extends in said filtration material in a manner spaced from each other, said plurality of heat transfer members being so oriented in relation to a direction of airflow through said filter so as to minimize a resistance to airflow.
